(19) United States
(12) Patent Application Publication
(10) Pub. No.: US 2009/0056070 A1
(43) Pub. Date: Mar. 5, 2009

(54) Adapter for mounting caster on height-adjustable leg

(76) Inventor: Jeffrey R. James, Columbus, OH (US)

Correspondence Address: DAVID A. GREENLEE, P.O. BOX 340557, COLUMBUS, OH, 43234, US

(21) Appl. No.: 11/897,317

(22) Filed: Aug. 30, 2007

(51) Int. Cl. B60B 33/00

(52) U.S. Cl. 16/45; 16/30

(57) ABSTRACT

Four leveling extensible legs are mounted on a heavy display case. These legs each include a cylindrical base mounted on the case which threadedly engages an inner cylindrical member that is extensible and retractable to engage the floor. An adapter includes a cylindrical body having a cavity that is closed at its distal end by a flange. This flange is bolted to a caster flange. The body is open at its proximal end to receive the leg inner member, a set screw releasably secures the adapter body and the attached caster to the leg inner member for movement therewith. This enables the display case to be moved during construction. The caster is easily removed by loosening the adapter set screw.

### BACKGROUND OF THE INVENTION

1. Technical Field

This invention relates generally to large, heavy display cases having height-adjustable legs and, more particularly, to an adapter for removable mounting a caster on such a leg.

2. Background Art

Manufacturers of heavy refrigerated and other types of display cases often must move the cases from location to location during the manufacturing process, and must move them onto trucks for delivery after the manufacturing process is completed. These cases are of the type shown in U.S. Pat. Nos. 6,560,842 and 6,111,224. These cases usually weigh in excess of 100 pounds when completed and are not readily movable manually. After delivery it is necessary to move these cases to an operational location of a store. Thereafter, it is often necessary to move these cases later because of a reconfiguration of the equipment used in the store layout.

Such cases cannot be merely picked up and moved by human power. Conventionally, during manufacture, such a case is lifted by fork lift and placed on a pallet that has casters. Then the case and pallet may be manually rolled to a new location, where it is usually off-loaded by fork lift. The case may be left on the pallet, which ties up a pallet and requires that the casters be chocked to maintain the case in position for subsequent assembly.

One solution to the problem of moving these heavy cases is to mount casters on the pallets, and then lift the case onto the pallet, which is then moved to the desired location. Such arrangements are shown in U.S. Pat. Nos. 6,450,515 and 4,576,391. However, when the desired location is reached, the case must be lifted off the pallet; subsequent movement requires re-palletizing and de-palletizing the case.

There is a need for a means and method of moving heavy cases during construction, and thereafter, that does not require palletizing and de-palletizing the case repeatedly.

It is usual to provide these heavy cases with four height-adjustable legs to enable leveling on non-level support surfaces, such as a floor of a store. These legs usually have a screw mechanism to enable selected legs to be manually extended for leveling. It has been proposed to provide such a screw mechanism with a cap or with an integral caster to enable movement of the case. However, this caster is an integral part of the extension mechanism, which prevents removal when an operational location for the case has been reached, requiring that the casters be chocked to prevent movement.

It would be desirable to provide a case with extensible legs that can be selectively move without palletizing, yet does not require chocking of the casters to immobilize the case.

### SUMMARY OF THE INVENTION

It is an object of this invention to provide a means and method of moving heavy cases during construction, and thereafter, that does not require palletizing and de-palletizing the case repeatedly.

It is another object of this invention to provide a case with extensible legs that can be selectively move without palletizing, yet does not require chocking of the casters to immobilize the case.

In one aspect, this invention comprises an adapter for mounting a caster on an extensible leg of a heavy case. The extensible leg includes a cylindrical base mounted on the case, an inner cylindrical member carried within the base for engaging a support surface, and threaded means interconnecting the base and inner member for enabling extension and retraction of the inner member relative to the base. The adapter has a body with a cavity that is closed at its distal end by a first flange, which is fastened to the first flange to a second flange mounted on a caster. The cavity is open at its proximal end to receive the inner member. Second connecting means releasably secure the adapter body to the leg inner member.

In another aspect, this invention comprises a method of moving a heavy display case during construction that comprises the steps of

providing the case with extensible legs, removably mounting a flanged adapter on each leg for movement therewith,
removably mounting a flanged caster on each adapter by connecting the flanges, moving the case on the rollers as needed during construction of the case,
lifting the case and removing the casters, and
lowering the case on a pallet by securing the adapter flange to the pallet.

These and other objects and features of this invention will become more readily apparent upon reference to the following detailed description of a preferred embodiment, as illustrated in the accompanying drawings, in which:

### DESCRIPTION OF THE DRAWINGS

FIG. 1 is a partial perspective view of an extensible leg of a display case;

FIG. 2 is a sectional view of the extensible leg of FIG. 1

FIG. 3 is a perspective view of an adapter, according to this invention;

FIG. 4 is a perspective view of a caster mounted on the adapter, according to this invention; and

FIG. 5 is a sectional view of the adapter and caster mounted on the extensible leg.

### DETAILED DESCRIPTION OF THE INVENTION

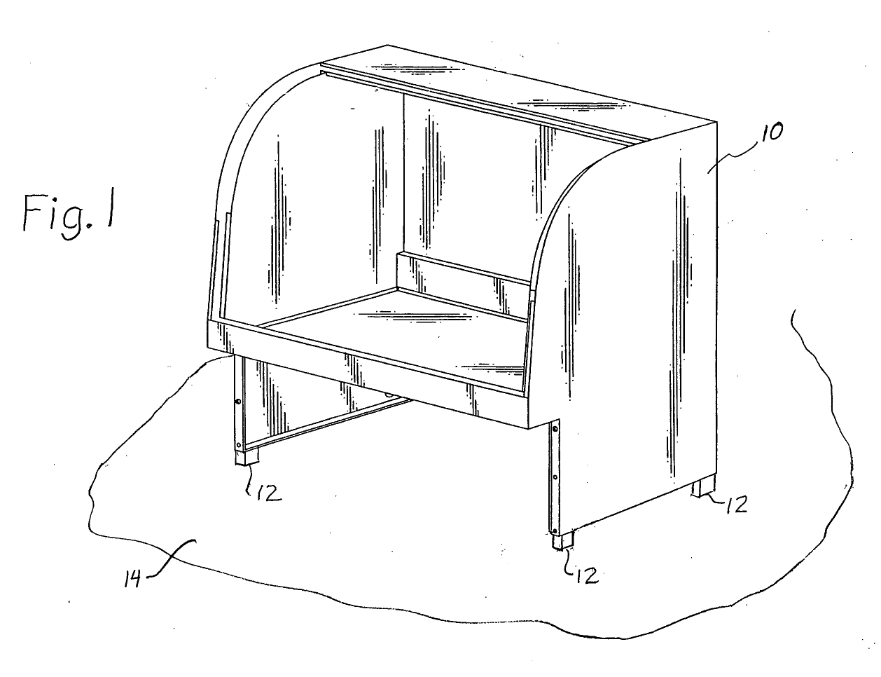

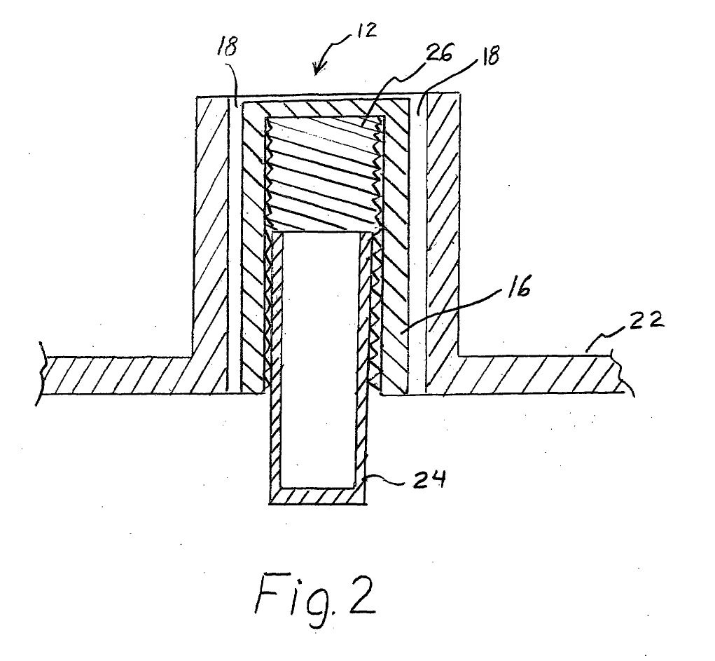

Referring now to FIG. 1, a display case 10 has four extensible legs 12 (only three illustrated) to support case 10 on a floor 14. These extensible legs enable leveling of the case to accommodate floor irregularities in a well-known manner. As shown in FIG. 2, extensible leg 12 includes a generally-cylindrical base 16 that has external ribs 18 that frictionally mount leg base 16 within a socket 20 mounted on the frame 22 of display case 10 in a well-known manner. An inner member 24 is threadedly received within the cylindrical cavity 26 of base 16. Inner members 24 of all legs 12 may be selectively screwed into and out of base 16 to level case 10 on floor 14.

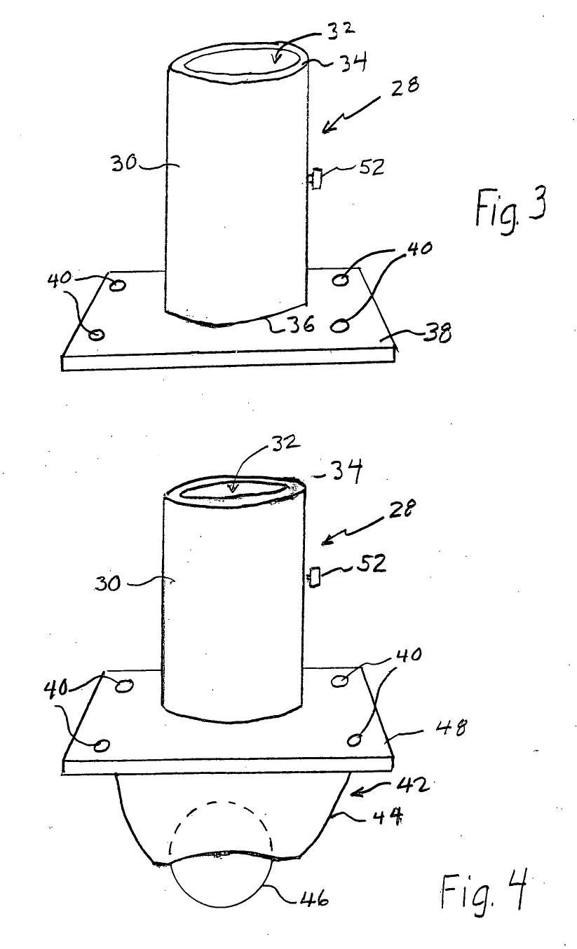

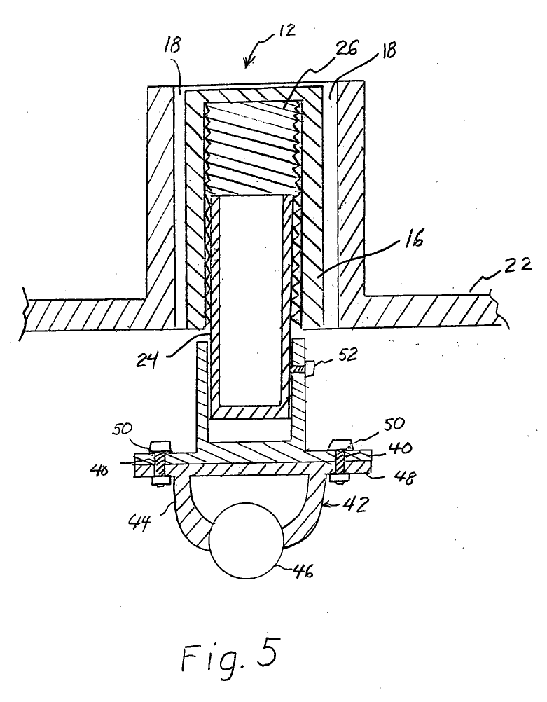

As shown in FIGS. 3 and 4, an adapter 28 includes a cylindrical body 30 having a cylindrical cavity 32 that is open at its proximal end 34. At its distal end 36, body 30 mounts a square plate or flange 38 that has apertures 40 at its four corners. A ball-type caster 42 has a housing 44 that mounts a caster ball 46 for rolling movement. Housing 44 has a flange or plate 48 that includes apertures (not illustrated) that mate with adapter apertures 40. Flange plates 38 and 48 are bolted together with bolts or other fasteners 50 to secure caster 42 to adapter 28.

As shown in FIGS. 3, 4 and 5, adapter body 30 receives extensible leg inner member 24 within cavity 32 in close fitting relationship. A set screw 52 carried by adapter body 30 is extensible to engage the outer surface of extensible leg inner member 24 to secure the adapter 28 and caster 42 for extension and retraction relative to leg base 16 and case frame 22. Adapter 28 and caster 42 may quickly be detached by merely loosening set screw 52.

Thus, it is readily apparent that adapter 28 and caster 42 may be easily attached to leg 12 to enable movement of display case 10 during construction and, when completed and delivered, around the store to a desired location. When lifted slightly, adapter 28 is easily removed for display case final installation. If it is ever desired to move display case 10 to a different location, the case is lifted, one leg at a time, and adapter 28 and caster 42 easily installed.

It is common to palletize these display cases for shipment. Once the adapter is mounted on the leg, the caster can be readily removed for palletizing (for delivery to a location), by removing the bolts to remove the caster and bolting or nailing the adapter flanges to the pallet. When the delivery is made, the bolts or nails are removed, case is lifted slightly by a fork lift, and the casters are bolted again to the adapter flanges. The case can then be readily rolled to the desired operational location.

While only a preferred embodiment has been described and shown, obvious modifications are contemplated within the scope of this invention as defined by the following claims.

I claim:

1. An adapter for mounting a caster on an extensible leg of a heavy case, said extensible leg including a cylindrical base mounted on the case, an inner cylindrical member carried within the base for engaging a support surface, and threaded means interconnecting the base and inner member for enabling extension and retraction of the inner member relative to the base, said adapter comprising a body having a cavity that is closed at its distal end by a first flange, said first flange having first connecting means fastening said first flange to a second flange mounted on a caster, said cavity being open at its proximal end for receiving said inner member, and including second connecting means releasably securing said adapter body to said leg inner member.

2. The adapter of claim 1, wherein said second connecting means is quickly releasable to enable removal from and mounting of the adapter on the leg.

3. The adapter of claim 2, wherein said adapter body cavity is cylindrical and fits closely about said leg inner member, and said first connecting means is a set screw movable through a radial threaded hole in said body to releasably secure said caster to said leg.

4. The adapter of claim 2, wherein said first connecting means are bolts.

5. The adapter of claim 1, wherein the adapter cavity is sized to fit closely about said leg inner member.

6. A method of moving a heavy display case during construction that comprises the steps of
providing the case with extensible legs, removably mounting a flanged adapter on each leg for movement therewith,
removably mounting a flanged caster on each adapter by connecting the flanges,
moving the case on the rollers as needed during construction of the case,
lifting the case and removing the casters, and
lowering the case on a pallet and securing the adapter flange to the pallet for shipment.
